(19) United States
(12) Patent Application Publication
(10) Pub. No.: US 2006/0095353 A1
(43) Pub. Date: May 4, 2006

(54) Indexed annuity system and method

(76) Inventor: Michael Scott Midlam, San Diego, CA (US)

Correspondence Address: Terrance A. Meador;INCAPLAW, Suite K, 1050 Rosecrans Street, San Diego, CA, 92106, US

(21) Appl. No.: 10/981,214

(22) Filed: Nov. 4, 2004

(51) Int. Cl. G06Q 40/00

(52) U.S. Cl. 705/35

(57) ABSTRACT

Growth in the accumulation value of an indexed annuity resulting from changes in value of an underlying index is realized for both positive and negative changes in the index's value through an index investment strategy based upon investment in financial instruments that produce returns when the value of the index rises as well as investment in instruments that produce returns when the value of the index falls. Such gains may be limited by two caps, one for returns resulting from growth of the value and the other for returns resulting from contraction of the value.

### FIELD

Gains are credited to an indexed annuity in the face of both upward and downward variation of an index or other reference underlying the annuity contract.

### DESCRIPTION OF THE RELATED ART

An annuity is a contract between an annuitant and a financial organization (assumed to be an insurer). Under the annuity contract, the annuitant pays one or more premiums and the insurer agrees to make at least one payment during the life of some person or group of persons. The accumulation value of an annuity is the aggregate of the premiums paid plus interest added or credited less costs, fees, and payments.

An indexed annuity is an annuity that credits gain to its accumulation value according to an algorithm based on changes in an economic index or other reference. An economic index is an indicator of economic activity. For example a hypothetical portfolio of stocks (a stock index) may be selected to indicate the performance of some sector of a stock market. The index's stock values are weighted and aggregated to provide a numerical measure of performance. The value of an index is typically tracked on a monthly basis with an annual gain calculated at the end of a calendar year by aggregating the monthly changes in the value of the index over the year. Well known stock indices include the Dow Jones Industrial Average and the Standard & Poors index of 500 stocks (“the S&P 500 Index”).

In an indexed annuity, some returns are determined with reference to one or more indexes. These returns may be denoted as “index-based” gains. An index that is used to determine gains credited to an indexed annuity is said to “underlie” or to be “linked to” the annuity. More than one economic index or reference may be used to determine the index-based gains of an indexed annuity. The index-based gains may be the only returns added to the annuity's value, or they may be in addition to interest and/or bonuses. Index-based gains are determined with reference to a term of time, an index term, with the gains credited to the accumulation value of the annuity periodically during the index term or once at the end of the index term. The index term may be one or more years, measured from the date of the annuity contract. A typical index term, for example, is a “policy year” measured from the anniversary date of the annuity contract. Various methods are used to calculate the index-based gain over the index term. For example, an index-based gain may be based on the difference between the value of an index at the beginning and end of the term. Or, the gain may be based on periodic changes in the value of the index. In this regard, an annual index-based gain may be calculated from the percentage increase in an index on which the annuity is based. An indexed annuity may be subject to a participation rate, that is to say, a percentage of the index-based gain calculated for the term. For example, if the index increases 8% over the term and the participation rate is 85%, the index-based gain could be calculated as 6.8%. Many indexed annuities are subject to a cap or upper limit on the index rate. A cap may be applied periodically during or over a term. Thus, if the annual cap in the previous example is 6%, then 6% will be credited to the annuity instead of 6.8%. Another feature of many indexed annuities is a floor, the minimum index-based gain that will be credited to the annuity value over the term. Typically, although not universally, a floor may be 0%. In this case, if an underlying index loses value during the term, the index-based gain will be 0%.

Index-based gains are generated for an index-based annuity by investing some designated percentage of the accumulation value in one or more investment portfolios. The returns on these investments are invested in an instrument linked to the underlying index. In practice more than one instrument and more than one index may be used to produce index-based gain. The returns on these instruments provide the index-based gain that is credited to the accumulation value.

One instrument used to generate returns for index-based gains is a call option. The call may be on some or all of the securities in the underlying index or on a security representing some or all of the securities in the underlying index. A “call option” or a “call” is an option contract between a buyer and seller. The buyer of the call pays a premium in return for which the seller of the call agrees to sell identified securities (such as shares of stock) at an agreed price (the “strike price”). The call has a specified period of time (“the option period”), usually a month, during which the buyer may exercise his right to buy the designated securities at the strike price. If the buyer exercises the option, the seller must sell the designated securities to the buyer at the strike price. Alternatively, the buyer may sell the call option contract. A call is generally regarded as an expression of opinion by the buyer that the value of the securities will rise.

Presume that one or more call options are bought on some or all of the securities in an underlying index, and that the aggregate price of the securities is the current value of the index. If the aggregate strike price is no more than the current price of the security, then if the current value of the index rises during the option period, and the purchaser exercises his right within the option period to buy at the strike prices or to sell the options, the purchaser can realize a return substantially equal to, if not more than, the rise in value of the index over the option period.

Index-based gains for an annuity indexed to the S&P 500 during the years 1975 and 1990 are illustrated in the chart of FIG. 1. In this example, index-based gains are credited annually, with the annuity contract date presumed to be Dec. 31, 1974. The annuity is capped and two exemplary caps, 3% and 3.2%, are shown. In this example, a cap is applied monthly and the gain over a one year period is the aggregate of the twelve capped monthly changes in index value during the year. A floor of 0% is applied annually. In this regard, the full value of all negative monthly changes in value is included in the aggregate of the capped monthly returns. If, at the end of the year, the aggregate is less than 0, 0 index-based gain is credited to the annuity value. The participation rate is presumed to be 100%. The figures in the month columns represent the percentage change in the value of the index for the month. Assuming a call option strategy producing yields equal to the monthly index return, it is manifest that the index-based gain was 9.1% under a 3% monthly cap over the one-year term in 1975 or 10.3% under a 3.2% monthly cap in the same term. For example, the return under the 3.0% cap is calculated as:
Return=3%+3%+2.2%+3%+3%+3%−6.8%−2.1%−3.5%+3%+2.5%−1.2%=9.1%

However in 1990, the negative yield on the index results in zero index-based gains under either cap.

In the example of FIG. 1, growth in the accumulation value of an indexed annuity resulting from index-based gains is limited to growth in the underlying index. But of course, growth in security values is not guaranteed. In fact, after two consecutive decades of near-record growth (the 1980s and 1990s), the S&P 500 Index lost value in each of 2000, 2001, and 2002. Manifestly, annuities linked to that index realized no returns from index-based gains during those years. Therefore, there is a need for a strategy to increase the index-based growth possibilities for an indexed annuity that avoids zero returns when the underlying index loses value.

### SUMMARY OF THE INVENTION

The invention is based on the critical realization that growth in the accumulation value of an indexed annuity resulting from changes in value of an underlying index can be realized in the face of both positive and negative changes in the index's value through an index investment strategy based upon investment in financial instruments that produce returns when the value rises as well as investment in instruments that produce returns when the value falls. Such a strategy, however, also requires the determination of two caps, one for returns resulting from growth of the value and the other for returns resulting from contraction of the value.

### BRIEF DESCRIPTION OF THE DRAWINGS

FIG. 1 is a chart showing a prior art index-based gain for an indexed annuity derived from gain in value of an underlying index;

FIG. 2 is a block diagram showing financial systems that function co-operatively to enable generation of index-based gains for an indexed annuity;

FIG. 3 is a block diagram of generation of index-based gains for an indexed annuity derived from gain and loss in value of an underlying index;

FIG. 4 is a diagram illustrating a gain module in FIG. 3;

FIG. 5 is a flow diagram of generation of index-based gains for an indexed annuity derived from gain and loss in value of an underlying index; and

FIG. 6 is a chart illustrating an example of index-based gain for an indexed annuity derived from gain and loss in value of an underlying index.

### SPECIFICATION

Gains are credited to an indexed annuity in the face of both gain and loss in the value of an underlying index according to a system and method that orders call and put investments in the index and applies a positive cap to gains resulting from growth of the index value and a negative cap to gains resulting from contraction of the index value.

As used in this specification, a “put option” or a “put” is an option contract between a buyer and seller. The buyer of the put pays a premium in return for which the seller of the put agrees to buy shares of an identified security (such as shares of stock) at an agreed price (the “strike price”). The put has a specified period of time (“the option period”), usually a month, during which the buyer may exercise his right to sell the designated securities at the strike price. If the buyer exercises the option, the seller must buy the designated securities from the buyer at the strike price. Alternatively, the buyer may sell the put option contract. A put is generally regarded as an expression of opinion by the buyer that the value of the securities will fall.

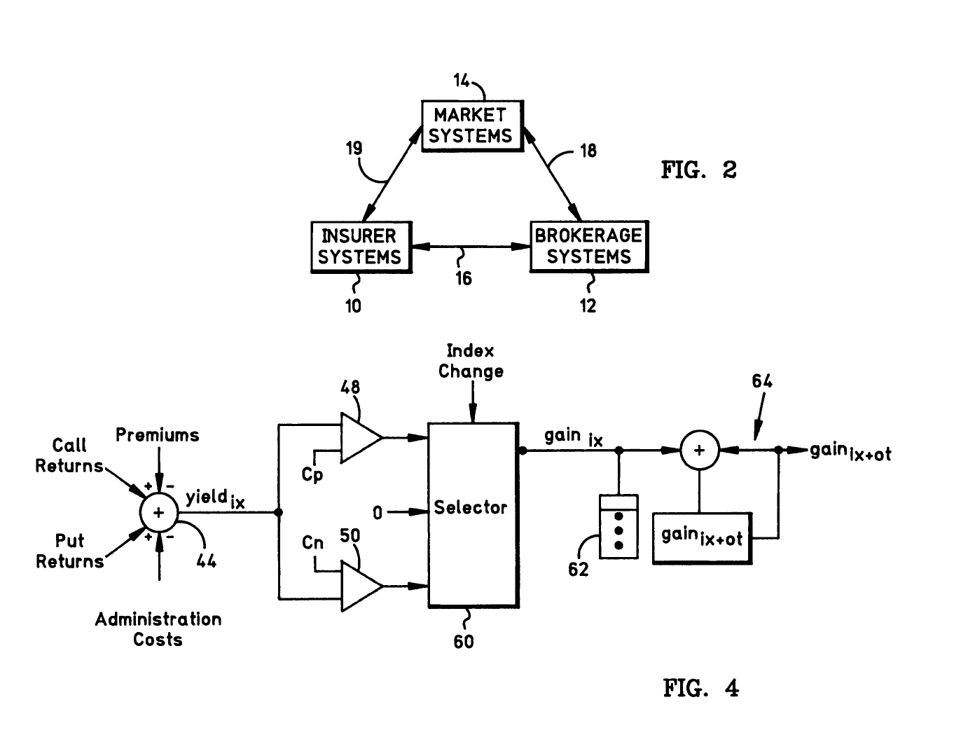

As shown in FIG. 2, the functions and acts that are set forth in this application may be implemented in one or more enterprise computing systems for, respectively, an insurer 10, a securities brokerage 12, and one or more securities exchanges or marketplaces 14. The insurer system 10 and the brokerage system 12 are linked to conduct automated financial transactions by a communications link 16; the brokerage system 12 and at least one exchange system 14 are linked to conduct automated securities transactions by a communications link 18; the insurer system 10 and at least one marketing system 14 are linked to provide financial and market information to the insurer system 10 by a communications link 19. The communications links 16 and 18 include interface and communications resources for formatting and communicating transaction information, while the respective enterprise systems that they link include processing resources for conducting financial and securities transactions by means of the transaction information communicated therebetween. The communications link 19 includes interface and communications resources for formatting and communicating market and financial information.

The insurer system (“insurer”) 10 includes an annuity management and transaction system; the brokerage system (“brokerage”) 12 includes a securities transaction system; and the at least one exchange or market system (“exchange”) 14 includes a securities trading system and, typically, a financial indicator reporting service. The insurer 10 and the brokerage 12 are typically distinct system entities that conduct financial transactions whereby the brokerage 12 maintains various investment portfolios and conducts various securities transactions with respect to those portfolios in response to orders from the insurer 10, and reports portfolio activity to the insurer. The at least one exchange 14 may have an integral brokerage component, such as a seat on the exchange possessed by the brokerage 12. The exchange 14 provides the brokerage 12 with access to automated trading of securities. The exchange 14 also has or has access to a financial and market information system from which subscribers including the insurer 10 obtain information relating to economic, market and financial activity.

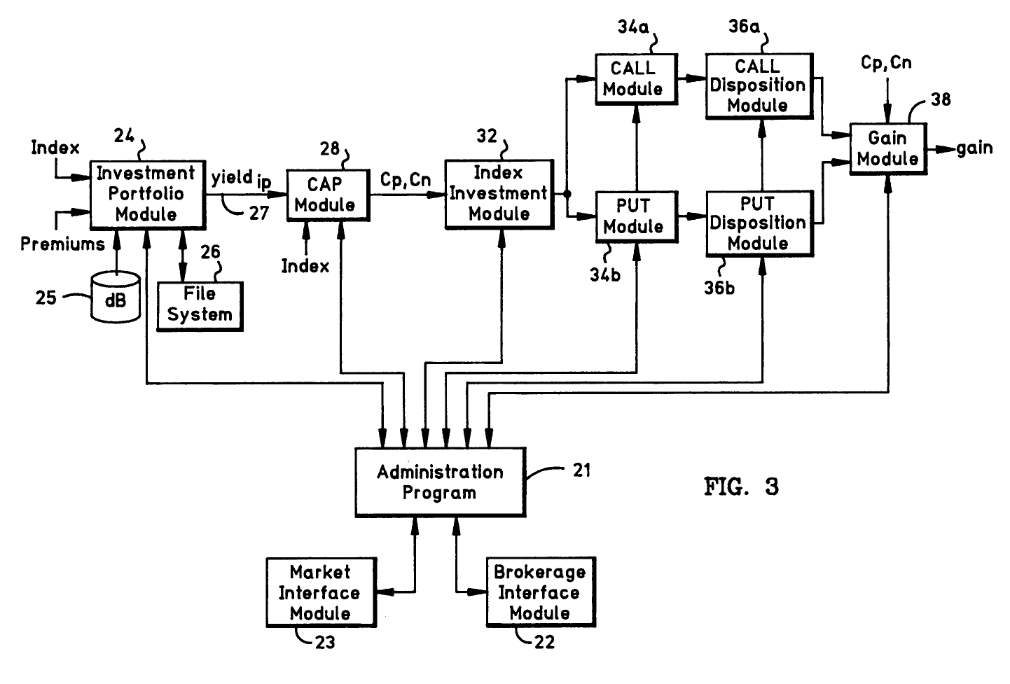

FIG. 3 illustrates a system 20 for managing an index-based annuity so as to share in returns derived from changes in the value of an underlying index, including both increases and decreases in the value. The operations performed by the system 20 constitute a method for the indexed annuity to participate in such returns. The system 20 is implemented in processing architecture integrated into the enterprise computing system of an insurer, for example the insurer 10. The specific implementation of the insurer's enterprise computing system is a matter of design choice by the reasonably skilled artisan. Nevertheless, such a system may entail a centrally-controlled or a server-based computing system with the capability of communicating externally of the insurer with one or more brokerages, markets, and/or exchanges. The system includes processing, database and file components that receive input information, conduct calculations and transactions, transmit, store, and retrieve information within the insurer system, conduct exchanges of information with one or more brokerages, issue orders, and cause the receipt, transfer and aggregation of finds, securities, interest, gains, and bonuses. This system is designed and programmed to:
receive and process actuarial, economic, financial and market information;
manage and administer annuities, including indexed annuities;
receive and process annuity premiums;
conduct investment portfolio transactions with one or more brokerages;
calculate participation rates and caps;
calculate option strategies;
issue orders to one or more brokerages for call and put options; and
issue orders to one or more brokerages for disposition of call and put options.

Although the system 20 is illustrated and described in terms of a single index, the intent is to show the system at its most elemental level in order to foster a clear understanding of how it works. In practice, an insurer could employ means to apply the system to more than one index.

The system 20 includes an administration program 21 that governs the functions of the system 20. The system 20 also includes brokerage and market interface modules 22 and 23. An annuitant enters into a contract with the insurer 10. The annuitant initially designates one or more indexes to link to the annuity. One or more premium payments (“Premiums”) according to the contract are received by the insurer 10 and allocated to one or more investment portfolios by an investment portfolio module 24. The investment portfolios are embodied in records contained in one or more databases 25 and file systems 26 that are maintained by the insurer 10 and are shared or accessed by one or more brokerages such as the brokerage 12 that buy and sell the securities in response to orders by the insurer 10. The investment portfolios are the underlying assets of the annuity contracts issued by the insurer 10. The constituents of the investment portfolios typically include US Treasury securities such as bonds, notes, and bills, corporate bonds, and other long-term securities whose prices are based on objective market interest rates. The investment portfolios produce returns denoted as “yieldᵢₚ” 27.

Information regarding all indices that may be linked to an annuity sold by the insurer 10 is received via the market interface module 23 and is processed by the system 20. In this regard, the market interface module 23 provides the system 20 with access to information regarding performance of one or more economic indices, market interest, stock market activity, and option market activity. A cap module 30 receives information concerning yieldᵢₚ, index performance, market interest, option market performance, actuarial statistics, and other factors useful in calculating caps for index-based annuities. The cap module, using this information, periodically calculates at least two caps for indexes that may be linked to an annuity sold by the insurer. A first cap Cₚ establishes a limit for positive changes (“the positive cap”) of an index. The second cap Cₙ establishes a limit for negative changes (“the negative cap”) of the index.

Investments of yieldᵢₚ in financial instruments that generate returns based upon index performance are determined and managed by an index investment module 32. The investments for index returns are short-term financial instruments linked to indices that underlie indexed annuities sold by the insurer. Preferably, these short-term financial interests include call and put options on securities related to the indices. The options may be for all securities in an index, a subset thereof, or may be for exchange index securities on the index itself. The index investment module 32 may execute one or more option investment models such as a Black-Scholes option pricing algorithm to calculate a strategy for making short-term option investments to derive gains from positive and negative variations in an index. For call options, the model is adjusted by Cₚ; for put options, the model is adjusted by Cₙ. An index investment strategy is calculated using values for known parameters, which may be derived from (without limitation) index performance, options sales activity, securities sales activity, market interest rates, and the values calculated for Cₚ and Cₙ. Each strategy is implemented with a call and a put option on each of one or more securities related to the index. For example, the strategy may embrace all of the stocks in an index, and would be implemented by call and put options on each stock. Each option is characterized by an identified security, a number of shares, an option period, a strike price, and a fair market value of the option. Thus, periodically, for each index, the index investment module 32 calculates an investment strategy and purchases call and put options to implement the strategy. The call and put options are paired or related in that a call and a put option is purchased for each security for the same option period. Call and put options are obtained by transmitting corresponding orders to a brokerage by way of call and put modules 34a and 34b. The brokerage returns information confirming purchase of the options and the prices (“premiums”) paid for the options.

During the option period for each call/put pair, the index investment module 32 continues to receive information about index performance, options sales activity, securities sales activity, and market interest rates and processes the information to produce a decision for disposing of each of the options. Relatedly, any call or put may be disposed of by exercising the option (buying or selling the security), by selling the option to another purchaser, or by electing not to exercise the option. Such dispositions are implemented by timely transmitting corresponding orders to the brokerage by means of modules 36a and 36b. The results of the dispositions are reported to the system 20 by the brokerage. The results obtained by disposition of all of the calls and puts for an index are accumulated in the respective modules 36a and 36b and the accumulated results are provided as outputs by the modules 36a and 36b. The disposition modules 36a and 36b provide these accumulated results to a gain module 38. The gain module 38 calculates index-based gain for an index based upon the accumulated results for the call and put options on the securities of the index.

The gain module 38 calculates a gain for an index over a measurement period and aggregates the gains for all of the measurement periods in any index term. The measurement period may be a month, for example, so that the index-based gain linked to an index may be tracked monthly. The total index-based gain for a year is then calculated by accumulating twelve successive monthly gains. An exemplary processing architecture for the gain module 38 is illustrated in FIG. 4.

With reference to FIG. 4, the gain module 38 obtains the yield (“yieldᵢₓ”) on an investment pairing call and put options on an index security by calculating the net of return from purchase or sale of the shares that are the subject of the options, or from sale of either or both options, less the premiums paid for both options and any administrative fees associated therewith. The gain module 38 calculates this value by combining the disposal results output by the disposal modules 36a and 36b with the premium and administrative cost information provided by the cost module 42 in an addition function 44. The addition function 44 provides yieldᵢₓ for comparison with the positive cap Cₚ in a comparator 48. The comparator 48 outputs yieldᵢₓ if its magnitude is less than the magnitude of Cₚ; when the magnitude of yieldᵢₓ equals or exceeds the magnitude of Cₚ, the comparator outputs Cₚ. In this manner, yieldᵢₓ is limited by the positive cap. The addition function 44 also provides yieldᵢₓ for comparison with the negative cap Cₙ in a comparator 50. The comparator 50 outputs yieldᵢₓ if its magnitude is less than the magnitude of Cₙ; when the magnitude of yieldᵢₓ equals or exceeds the magnitude of Cₙ, the comparator outputs Cₙ. In this manner, yieldᵢₓ is limited by the negative cap. A selector 60 receives the outputs of the comparators 48 and 50 and also receives a hard-wired value of zero. The selector 60 selects among these three inputs according to a change in the value of the index over a measurement period. The output of the selector 60 is denominated gainₛ, that is to say, the gain realized during the measurement period by the call/put option pair on one security in or on the index. An accumulator 61 sums the gain index-based gain over the measurement period. A sequence 62 of information storage locations contains successive values of gainᵢₓ, each calculated for a respective measurement period. An accumulator 64 totals and stores the current sum of all the calculated values of gainᵢₓ for the index. Thus, at the end of the current index term, the accumulator will contain all of the individual values of gainᵢₓ for the index calculated over the term as well as the sum of all those values. At the end of the term, the sum of the values represents the index-based gain (gainᵢₓₜₒₜ) for an annuity linked to the index.

Thus, for an annuity with an index term of one year and with monthly updates of the index investment strategy, call and a put options on the index will be purchased each month, twelve values of gainᵢₓ will be calculated over the year and accumulated into a single value for gainᵢₓₜₒₜ. The gain module 38 determines the index-based gain for each measuring period (each month, in this example) as follows:
if gainᵢₓ results from a gain in the index, then
gainᵢₓ=yieldᵢₓ, if yieldᵢₓ<Cₚ, or gainᵢₓ=Cₚ if yieldᵢₓ≧Cₚ; or
if gainᵢₓ results from a loss in the index, then
gainᵢₓ=yieldᵢₓ if yieldᵢₓ<Cₙ, or gainᵢₓ=Cₙ if yieldᵢₓ≧Cₙ; otherwise,
gainᵢₓ=0.

The total gain over the index term is determined as follows:
gainᵢₓₜₒₜ=Σ(gainᵢₓ)ⱼ
where the subscript j denotes the measuring period of a gainᵢₓ calculated during the index term and Σ denotes the sum of all values of gainᵢₓ calculated during the term. For example, if the index term is one year, and the measuring period is a month, the values of j will be the integers from 1 to 12.

With access to all of the gain values calculated by the gain module 38, the administrative module 21 determines, for each index, the respective amounts to be added to the accumulation values of annuities linked thereto resulting from the gain realized from the change in value of the index and credits each of these amounts to a respective annuity.

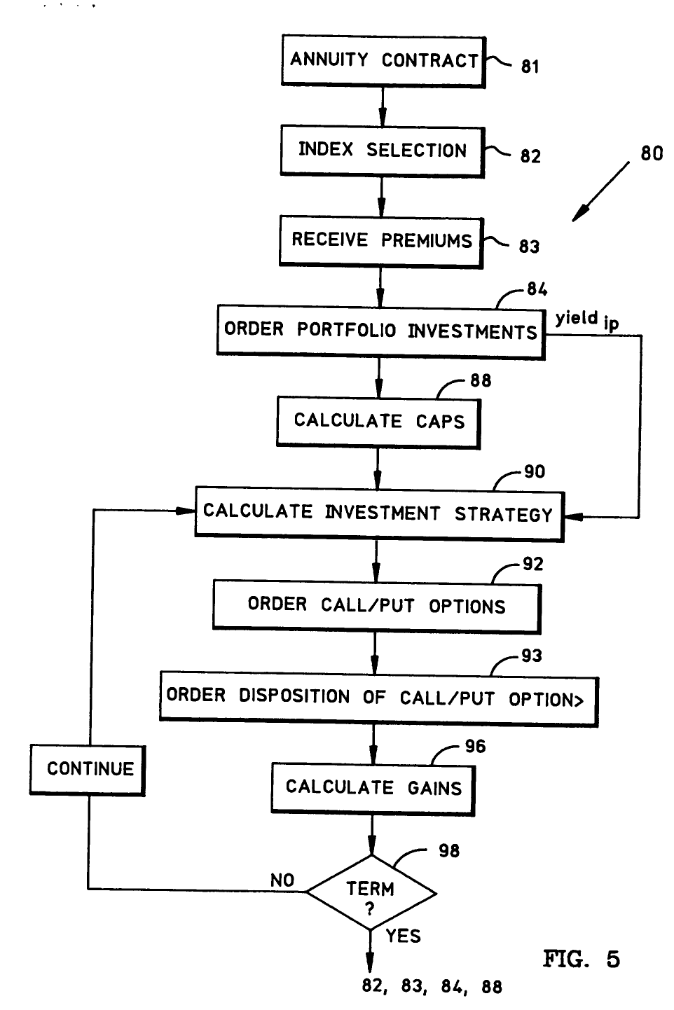

A method 80 for determining and crediting gains to an indexed annuity in the face of both growth and contraction of the value of the underlying index is illustrated in FIG. 8. The assumptions made to explain the method 80 are a one year index term with a monthly measuring period, a single annuity, and a single underlying index. The intent of these assumptions is not to limit the practice of the method 80 to the assumed facts, rather it is to show the process at its most elemental level in order to foster a clear understanding of how it works. In practice, an insurer could employ means to use different index terms and measuring periods and could apply the method to more than one annuity and more than one index. The method 80 of FIG. 5 may be practiced by an insurer such as the insurer 10 using an integrated annuity management system that includes a system for determining and generating index-based gains for an indexed annuity such as the system 20 illustrated in FIG. 3.

In the method 80, a purchaser initially enters into a contract with an insurer for an indexed annuity and selects one or more indices to which the annuity is to be linked. The purchaser may also specify allocations of the value of the annuity in respective separate portions to accumulate value in the form of index-based gains and/or to earn interest at a rate fixed over some period. In step 81, the insurer receives an order from the purchaser for the annuity; in step 82, the order includes identification of one or more indices to be linked to the annuity. In step 83, the insurer receives one or more fund transfers from a financial institution acting on behalf of the purchaser, such as a bank, for premiums for the annuity. One or more orders are transmitted by the insurer to a brokerage for investing the premiums in one or more investment portfolios in step 84, and a yield, yieldᵢₚ, is realized from those investments is reported by the brokerage to the insurer. In step 88, positive and negative caps are calculated by the insurer for a selected index. An investment strategy including pairs of call and put options to buy and sell securities of and/or on the index is calculated in step 90. Orders are periodically transmitted to the brokerage to buy the options in step 92, followed by orders for disposition of those pairs within an option period in step 94. Then, in step 96, gains, including gainᵢₓ and gainᵢₓₜₒₜ, produced by the accumulated dispositions of the call and put options is calculated. In the example of FIG. 5, presume that changes in the index's value are reported monthly. Presume further that orders are transmitted for purchasing at least one call option and one put option covering each of a plurality of securities in and/or on the index at or near the end of each month, with the option period extending over all or part of the following month. Thus, measured by the term for calculating index-based gains for the annuity (presume one year) the sequence 90, 92, 93, 96, is executed monthly, cycling through the decision 98 until the term is completed, by which time the twelve values of gainᵢₓ will be aggregated in gainᵢₓₜₒₜ, the index-based return for the term, and an amount based on gainᵢₓₜₒₜ will be credited to the annuity's accumulation value. If the annuity has not been surrendered, the method may loop back through step 82 if the index is changed, through step 83 if premiums are paid annually, through step 84 if investments are adjusted or updated annually, or through step 88.

For an example of the operation of the system 20 and the method 80, refer to FIG. 6 which illustrates gains realized by a call/put strategy for an annuity linked to the S&P 500 index. In this example, the negative and positive caps are calculated for policy years corresponding to the calendar years 1975 and 1990. The caps are assumed to be 1.5% each for gains and losses realized on an investment strategy that buys a call/put pair on the index each month. The participation rate is assumed to be 100%. In this example, in April 1975, call and put options for May are purchased for one or more securities in the index, for example for all securities in the index, each at a strike price equal to the index-weighted value of the corresponding security at the end of April. By the end of May 1975, the value of the index has risen by 4.4%, leading to exercise or sale of the call options and no action on the put options. Because of the magnitude of the gain by the index during May, the insurer can dispose of the call options at an aggregate price that covers the positive cap, the premiums on the call and put options, and administrative costs. The result is that the increase in value of the index in May, limited by the positive cap, produces a gainᵢₓ of 1.5% for an annuity linked to the S&P 500 Index at little or no cost to the insurer.

Similarly, in June 1975, call and put options for July are purchased for the index securities, each at a strike price equal to the index-weighted value of the security at the end of June. By the end of July 1975, the value of the index has dropped by 6.8%, leading to exercise or sale of the put options and no action on the call options. Because of the magnitude of the (negative) gain by the index during July, the insurer can dispose of the put options at a price that covers the negative cap, the premiums on the call and put options, and administrative costs. The result is that the decrease in value of the index in June, limited by the negative cap, produces a yieldᵢₓ of 1.5% for an annuity at little or no cost to the insurer.

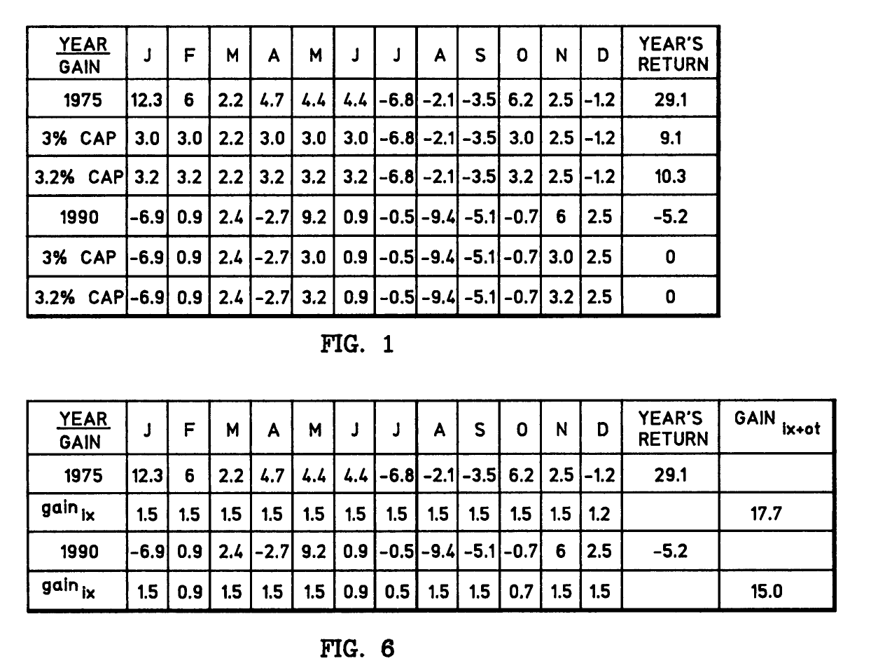

The gain credited to the annuity at the end of each year under the conditions of this example in FIG. 6 may be compared with the gains realized with a single positive cap illustrated in FIG. 1. Manifestly, the gains for an indexed annuity under the conditions given are greater in these two years with yields based upon the call/put strategy than with yields based on the call strategy, even with a higher positive cap in the call strategy case.

Although the specification has described a indexed annuity system and method with reference to specific examples and illustrations, it should be understood that various modifications can be made without departing from the principles underlying those examples and illustrations. For example, the annuity contract may provide for changing the index or indexes to which the annuity is linked. Further, although the caps are disclosed as being equal in magnitude, sound principles may dictate that they have unequal magnitudes. Moreover, some indexed annuities may use the call/put option strategy without caps. Accordingly, the scope of any invention described in this specification is limited only by the following claims.

1. A method for determining index-based gains for an indexed annuity purchased by a purchaser, comprising:
receiving a designation of an index to be linked to the annuity;
ordering an investment of a value of the annuity in an investment portfolio;
determining a positive cap (Cₚ) and a negative cap (Cₙ);
receiving a yield (yieldᵢₚ) from the investment of the premium;
ordering call and put investments of yieldᵢₚ in securities of the index;
calculating a yield (yieldᵢₓ) from the call and put investments;
calculating an index-based gain for the annuity based on yields of the call and put investments; and
limiting the index-based gain by either Cₚ or Cₙ.

2. The method of claim 1 wherein the index-based gain (gainᵢₓ) is calculated by:
if the value of the index increases, then
gainᵢₓ=yieldᵢₓ, if yieldᵢₓ<Cₚ, or gainᵢₓ=Cₚ if yieldᵢₓ≧Cₚ; otherwise
if the value of the index decreases, then
gainᵢₓ=yieldᵢₓ if yieldᵢₓ<Cₙ, or gainᵢₓ=Cₙ if yieldᵢₓ≧Cₙ.

3. The method of claim 1, wherein the value is an accumulated value of the annuity.

4. The method of claim 1, wherein the annuity has an accumulated value and the invested value is a portion of the accumulated value designated by the purchaser for yielding gains based upon changes in the index.

5. The method of claim 3, wherein the invested value is also designated for earning a fixed interest.

6. The method of claim 2, wherein the sequence of the ordering call and put investments and calculating yieldᵢₓ is performed iteratively for a predetermined period of time, and the act of calculating the index-based gain includes aggregating the values of gainᵢₓ in a cumulative value of gainᵢₓₜₒₜ over the predetermined period of time.

7. The method of claim 6, wherein the predetermined period of time is one year.

8. The method of claim 7, wherein the value is an accumulated value of the annuity.

9. The method of claim 7, wherein the annuity has an accumulated value and the invested value is a portion of the accumulated value designated by the purchaser for yielding gains based upon changes in the index.

10. The method of claim 9, wherein the invested value is also designated for earning a fixed interest.

11. The method of claim 10, wherein the index is the S&P 500 Index.

12. An enterprise computing system for determining index-based gain for an indexed annuity purchased by a purchaser, comprising:
means for receiving a designation of an index to be linked to the annuity;
means for ordering from a brokerage an investment of a value of the annuity in an investment portfolio;
means for determining a positive cap (Cₚ) and a negative cap (Cₙ);
means for receiving from the brokerage a yield (yieldᵢₚ) from the investment of the premium;
means for periodically ordering from the brokerage paired call and put investments of yieldᵢₚ in securities of the index;
means for calculating a yield (yieldᵢₓ) from the pairs of call and put investments; and
means for calculating a value for the index-based gain (gainᵢₓ) for the annuity based upon:
if the gain results from an increase in the value of the index, then
gainᵢₓ=yieldᵢₓ if yieldᵢₓ<Cₚ, or Cₚ if yieldᵢₓ≧Cₚ; otherwise
if the gain results from a decrease in the value of the index, then
gainᵢₓ=yieldᵢₓ if yieldᵢₓ<Cₙ, or Cₙ if yieldᵢₓ≧Cₙ.

13. The method of claim 12, wherein the value is an accumulated value of the annuity.

14. The method of claim 12, wherein the means for periodically ordering and the means for periodically calculating yieldᵢₓ operate iteratively for a predetermined period of time, and the means for calculating yieldᵢₓₜₒₜ includes means for aggregating the values of yieldᵢₓ over the predetermined period of time.

15. The method of claim 14, wherein the predetermined period of time is one year.

16. The method of claim 15, wherein the value is an accumulated value of the annuity.

17. The method of claim 16, wherein the annuity has an accumulated value and the invested value is a portion of the accumulated value designated by the purchaser for yielding gains based upon changes in the index.

18. The method of claim 17, wherein the invested value is also designated for earning a fixed interest.

19. The method of claim 18, wherein the index is the S&P 500 Index.

20. A method for determining index-based gain for an indexed annuity having a premium value, comprising:
receiving a designation of at least one index to be linked to the annuity;
ordering an investment of at least a portion of the premium value;
receiving a yield (yieldᵢₚ) from the investment of the premium value;
ordering call and put investments of yieldᵢₚ in at least one security of the at least one index;
calculating a yield (yieldᵢₓ) from the call and put investments; and
determining the index-based gain for the annuity based upon yieldᵢₓ.

21. The method of claim 20, further including:
capping yieldᵢₓ with a positive cap if a value of the index increases during the call and put investments; and
capping yieldᵢₓ with a negative cap if the value of the index decreases during the call and put investments.

22. A method for managing the value of an indexed annuity having a premium value, comprising:
receiving a yield (yieldᵢₚ) from an investment of the premium value;
ordering call and put investments of yieldᵢₚ in at least one security of an index linked to the annuity;
calculating a yield (yieldᵢₓ) from the call and put investments; and
determining the index-based gain for the annuity based upon yieldᵢₓ.

23. The method of claim 22, further including:
capping yieldᵢₓ with a positive cap if a value of the index increases during the call and put investments; and
capping yieldᵢₓ with a negative cap if the value of the index decreases during the call and put investments.

24. The method of claim 22, further including:
capping yieldᵢₓ with a positive cap or a negative cap.

25. A method for managing the value of an indexed annuity having a premium value, comprising:
receiving a yield (yieldᵢₚ) from an investment of the premium value; and, iteratively
ordering call and put investments of yieldᵢₚ in at least one security of an index linked to the annuity;
calculating a yield value (yieldᵢₓ) from the call and put investments;
determining the index-based gain for the annuity based upon yieldᵢₓ; and
aggregating yield values during the iteration.

26. The method of claim 25, wherein calculating yieldᵢₓ includes capping yieldᵢₓ with a positive cap or a negative cap.

27. The method of claim 26, further including adding aggregated yield values to an accumulated value of the annuity.
